(19) United States
(12) Patent Application Publication
(10) Pub. No.: US 2014/0129033 A1
(43) Pub. Date: May 8, 2014

(54) Furniture Fitting for a Movable Furniture Part, and Piece of Furniture

(71) Applicant: Holger Wenzel, Lindau (DE)

(72) Inventor: Holger Wenzel, Lindau (DE)

(73) Assignee: GRASS GMBH, Hochst (AT)

(21) Appl. No.: 14/116,618

(22) PCT Filed: May 11, 2012
(86) PCT No.: PCT/EP2012/002032

§ 371 Date: Jan. 14, 2014

(30) Foreign Application Priority Data
May 12, 2011 (DE) 202011100577.5

(51) Int. Cl. G05D 27/02

(52) U.S. Cl. CPC G05D 27/02
USPC 700/275

(57) ABSTRACT

In a furniture fitting for a movable furniture part, in particular a shutter, door or drawer, having an actuating drive, via which the movable furniture part can be driven, the furniture fitting has arranged in or on it a sensor means via which, with the furniture fitting installed in the use state, physical state variables to which the movable furniture part is subjected via the user, and which serve for monitoring the movement of said furniture part, can be sent and transmitted by signal transmission for the purpose of controlling the actuating drive in dependence on at least one of the sensed physical state variables.

The invention relates to a furniture fitting for a movable furniture part, in particular a flap, door or drawer, having an actuating drive via which the movable furniture part can be driven.

A furniture fitting of this type is known, for example, from EP2248981 A1. The flap fitting disclosed therein for a furniture flap has an actuating drive which acts on an actuating arm of the fitting which in turn is connected to the furniture flap.

Drawers driven by actuating drives are also further known from the prior art.

An object of the invention is to provide a furniture fitting or a piece of furniture of the type mentioned in the introduction, in which the movable furniture part can be operated in an even more comfortable manner. In particular, an intuitive operation of the movable furniture part is thereby intended to be possible.

This object is achieved by a furniture fitting for a movable furniture part according to the features of independent claim 1 and a piece of furniture according to the features of independent claim 11. Developments of the invention are set out in the dependent claims.

The furniture fitting according to the invention is distinguished in that there is arranged on or in the furniture fitting a sensor device, via which, in the assembled useful state of the furniture fitting, physical state variables which act via the user on the movable furniture part and which are used for controlling the movement thereof can be detected and can be transmitted by means of signal transmission in order to control the electrical drive in accordance with at least one of the detected physical state variables.

A significant element of the invention is the sensor device which is arranged or mounted on or in the furniture fitting. The sensor device allows physical state variables to be detected or measured, the actuating drive and therefore the movable furniture part being able to be controlled with at least one of the measured physical state variables. The physical state variables which can be measured or detected via the sensory device may be, for example, force, pressure, speed, acceleration, time and/or displacement. The movably received furniture part may be, for example, a drawer or a pull-out member which is movably received by means of a guide unit so as to be displaceable on a furniture carcass, or a door, flap or the like which can be pivoted relative to a furniture carcass.

The detected or measured at least one physical state variable therefore constitutes a control or regulating variable for the actuating drive. This may be controlled or adjusted, for example, with regard to its speed or its torque. Therefore, it is thereby possible to impart a specific movement course to the movable furniture part in accordance with the at least one detected physical state variable. For example, it is possible to move the movable furniture part in such a manner that an active accompanying movement by the user is no longer necessary. The user could therefore let go. However, it is also possible to control or adjust the actuating drive in such a manner that an active movement support of the movable furniture part by the user is possible.

An important aspect of the invention is the arrangement of the sensor device on or in the furniture fitting. The sensor device may, for example, be integrated in the furniture fitting. Therefore, it is unnecessary to have an additional assembly interface for assembly of the sensor device on the associated piece of furniture, which is positioned remote from the assembly interface for the furniture fitting. During the assembly of the furniture fitting, therefore, the sensor device is already generally provided so that an additional assembly of the sensor device is unnecessary. Naturally, it would also be possible to fix the sensor device to the furniture fitting subsequently, in the assembled useful state of the furniture fitting. In any case, the spatial requirement of such a structural unit comprising a furniture fitting with a sensor device is far smaller than if the sensor device is located on an assembly interface arranged remote from the furniture fitting. Furthermore, in such a configuration the transmission paths for the signal transmission are very short so that a cable-supported signal transmission would also be conceivable in addition to a wireless signal transmission of the detected physical state variables which are converted into signals.

In a development of the invention, the sensor device is in the form of a subassembly which is constructed separately from the furniture fitting and which can be assembled releasably in or on the furniture fitting. Such a construction allows the subsequent installation of sensor devices on furniture fittings already assembled on pieces of furniture. Furthermore, the disassembly of such modular sensor devices is readily possible, which involves advantages in the maintenance and/or exchange of defective sensor devices.

In order to measure or to detect the physical state variables, the sensor device advantageously has at least one state variable recorder. In a particularly preferred manner, the state variable recorder is in the form of a state variable sensor, the measured physical state variable being converted in particular by means of a measurement convertor into an electrical voltage which may be increased via a measurement amplifier.

In order to detect force applied by the user to the movable furniture part, therefore, a force transducer, for example, force sensor, can be used. The sensor device may therefore comprise a force sensor unit. All conceivable types of force transducers or force sensors can be used, for example, ones which are provided with expansion measurement strips, whose electrical resistance changes with expansion. An alternative to these would be piezoelectric force transducers. These are particularly suitable for highly dynamic force measurement. The sensor device can therefore comprise a force sensor unit which measures the force which the user applies from the outer side to the movable furniture part, and preferably transmits it as an electrical force measurement value signal, whereby the drive power of the actuating drive can be controlled or adjusted.

Users operate movable furniture parts in very different manners. Whereas some users carefully operate the movable furniture part with a relatively small force, for example, open it or close it, other users tend to move the movable furniture part in an abrupt manner, that is to say, with great force. The force currently applied by the user can therefore be measured by means of the force transducer. The force detected acts as a control or adjustment variable for the actuating drive so that the actuating drive in the example of a measured high force is controlled or adjusted in such a manner that braking of the movable furniture part is brought about. It is thereby possible to prevent, for example, a hard impact in the end position or, in the case of an end position damping, an excessively powerful loading of the end position damping. Conversely, in the case of a low force being detected, it is possible to accelerate the movable furniture part, whereby the continued movement of the movable furniture part by the user can be actively supported. It is further possible to recognise a blocking operation my means of force measurement if, for example, an object is in the movement path of the movable furniture part. In this instance, the measured force becomes very large in an abrupt manner and the actuating drive can be controlled in such a manner that it stops or changes its drive direction.

In a development of the invention, the state variable recorder is in the form of a displacement transducer, in particular a displacement sensor, in order to detect the movement path of the movable furniture part. All conceivable types of displacement sensors can be used, for example, inductive displacement sensors or displacement sensors having linear or rotary potentiometers. It is possible, for example, to establish the absolute position of the movable furniture part without reference travel being necessary.

In a development of the invention, the state variable sensor is operated with auxiliary electrical energy which can preferably be obtained from the movement of the movable furniture part. It is thereby possible to dispense with batteries or accumulators for electrical power supply. Naturally, it is also possible, alternatively or additionally, to operate the state variable sensor with batteries or accumulators.

In a particularly preferred manner, the sensor device has a control or adjustment unit for controlling or adjusting the actuating drive. It is possible to carry out the signal processing inside the control or adjustment unit. To this end, the control or adjustment unit may be provided, for example, with a processor. Alternatively or in addition to the control or adjustment unit on-board the sensor device, it is also possible to use an external control or adjustment unit. In a preferred manner, the control or adjustment unit controls/adjusts the actuating drive with regard to the speed or torque thereof.

In a development of the invention, the sensor device has a data store, in which desired values of specific physical state variables and/or movement profiles are stored or can be stored. The movement profiles can each be associated with a specific movement situation of the movable furniture part, which movement situation is triggered from the outer side by an action on the movable furniture part and can be described by physical state variables. A specific associated movement profile can then be called up from the data store by means of at least one detected physical state variable, whereby the actuating drive can be controlled in accordance with the movement profile called up.

The sensor device advantageously has a comparison unit for comparing detected physical state variables with associated physical state variables which are stored in the data store. These may be, as mentioned, desired values of specific physical state variables, whereby the comparison unit can carry out a desired/actual value comparison. For example, it would be possible to fix an upper limit for a maximum force to be applied to the movable furniture part or an upper limit for a maximum acceleration to be applied to the movable furniture part and, in the event of this limit being exceeded—established by the actual/desired value comparison-braking of the movable furniture part is brought about. Naturally, alternatively or additionally, there may also be fixed lower limits and, in the event of a value falling below this limit, an acceleration of the movable furniture part is initiated.

It is particularly advantageous to store in the data store specific movement profiles, of which a specific profile which subsequently begins to be carried out can be called up by the at least one physical state variable detected.

In a development of the invention, the sensor device is configured for a wireless signal transmission between itself and the actuating drive.

In a particularly preferable manner, the actuating drive is in the form of an electrical actuating drive. In principle, a fluidic, preferably pneumatic actuating drive would also be able to be used.

1. A furniture fitting for a movable furniture part, in particular a flap, door or drawer, having an actuating drive via which the movable furniture part can be driven, wherein there is arranged on or in the furniture fitting a sensor device, via which, in the assembled useful state of the furniture fitting, physical state variables which act via the user on the movable furniture part and which are used for controlling the movement thereof can be detected and can be transmitted by means of signal transmission in order to control the electrical drive in accordance with at least one of the detected physical state variables.

2. A furniture fitting according to claim 1, wherein the sensor device is in the form of a subassembly which is constructed separately from the furniture fitting and which can be assembled releasably in or on the furniture fitting.

3. A furniture fitting according to claim 1, wherein the sensor device has at least one state variable recorder.

4. A furniture fitting according to claim 3, wherein the state variable recorder is in the form of a force transducer in order to detect force applied by the user to the movable furniture part.

5. A furniture fitting according to claim 3, wherein the state variable recorder is in the form of a displacement transducer in order to detect the movement path of the movable furniture part.

6. A furniture fitting according to claim 3, wherein the state variable recorder is a state variable sensor which can be operated with auxiliary electrical energy obtained from the movement of the movable furniture part.

7. A furniture fitting according to claim 1, wherein the sensor device has a control or adjustment unit for controlling or adjusting the actuating drive.

8. A furniture fitting according to claim 1, wherein the sensor device has a data store, in which movement profiles of the movable furniture part are stored or can be stored.

9. A furniture fitting according to claim 1, wherein the sensor device is configured for a wireless signal transmission between itself and the actuating drive.

10. A furniture fitting according to claim 1, wherein the actuating drive is in the form of an electrical actuating drive.

11. A piece of furniture having at least one movable furniture part, such as a flap, door or drawer, comprising a furniture fitting according to claim 1.
